(19) United States
(12) Patent Application Publication
(10) Pub. No.: US 2025/0274741 A1
(43) Pub. Date: Aug. 28, 2025

(54) TECHNOLOGIES FOR MANAGING REDUCED CAPABILITY USER EQUIPMENTS IN WIRELESS NETWORKS

(71) Applicant: Apple Inc., Cupertino, CA (US)

(72) Inventors: Naveen Kumar R. Palle Venkata, San Diego, CA (US); Alexander Sirotkin, Tel Aviv (IL); Fangli Xu, Beijing (CN); Haijing Hu, Los Gatos, CA (US); Pavan Nuggehalli, San Carlos, CA (US); Ralf Rossbach, Munich (DE); Sethuraman Gurumoorthy, San Ramon, CA (US); Yuqin Chen, Beijing (CN); Zhibin Wu, Los Altos, CA (US)

(73) Assignee: Apple Inc., Cupertino, CA (US)

(21) Appl. No.: 18/858,274

(22) PCT Filed: Apr. 12, 2023
(86) PCT No.: PCT/US2023/018334

§ 371 Date: Oct. 18, 2024

Related U.S. Application Data
(60) Provisional application No. 63/333,066, filed on Apr. 20, 2022.

(51) Int. Cl. H04W 8/22; H04L 27/26; H04W 52/36; H04W 76/30

(52) U.S. Cl. CPC H04W 8/22; H04L 27/26025; H04W 52/367; H04W 76/30

(57) ABSTRACT

The present application relates to devices and components including apparatuses, systems, and methods for managing reduced capability user equipments in wireless networks.

### CROSS REFERENCE TO RELATED APPLICATION

This application claims priority to U.S. Provisional Application No. 63/333,066, filed Apr. 20, 2022. The contents of said application is hereby incorporated by reference in its entirety.

### FIELD

The present application relates to the field of wireless networks and, in particular, to managing reduced capability user equipment in said networks.

### BACKGROUND

Reduced-capability (redcap) New Radio (NR) devices may be used in Third Generation Partnership Project (3GPP) networks. Features and parameter lists with lower-end capabilities may be needed relative to Release 16 and future releases enhanced mobile broadband (eMBB) and ultra-reliable and low-latency communication (URLCC) in NR. These redcap devices may be used for industrial wireless sensors, video surveillance, or wearable devices. With respect to non-recap UEs, redcap UEs may have less receive/transmit antennas, reduced bandwidth, half-duplex frequency division duplexing (instead of full-duplex), relaxed UE processing time, and relaxed UE processing capability.

### BRIEF DESCRIPTION OF THE DRAWINGS

FIG. 1 illustrates a network environment in accordance with some embodiments.

FIG. 2 illustrates a test-capability structure and a corresponding bitstream in accordance with some embodiments.

FIG. 3 illustrates the test-capability structure and corresponding bitstreams in accordance with some embodiments.

FIG. 4 illustrates a band NR sequence in accordance with some embodiments.

FIG. 5 illustrates a signaling diagram in accordance with some embodiments.

FIG. 6 illustrates another signaling diagram in accordance with some embodiments.

FIG. 7 illustrates another signaling diagram in accordance with some embodiments.

FIG. 8 illustrates another signaling diagram in accordance with some embodiments.

FIG. 9 illustrates information elements in accordance with some embodiments.

FIG. 10 illustrates another signaling diagram in accordance with some embodiments.

FIG. 11 illustrates another signaling diagram in accordance with some embodiments.

FIG. 12 illustrates another signaling diagram in accordance with some embodiments.

FIG. 13 illustrates another signaling diagram in accordance with some embodiments.

FIG. 14 illustrates an operational flow/algorithmic structure in accordance with some embodiments.

FIG. 15 illustrates another operational flow/algorithmic structure in accordance with some embodiments.

FIG. 16 illustrates another operational flow/algorithmic structure in accordance with some embodiments.

FIG. 17 illustrates a user equipment in accordance with some embodiments.

FIG. 18 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B).

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, or network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

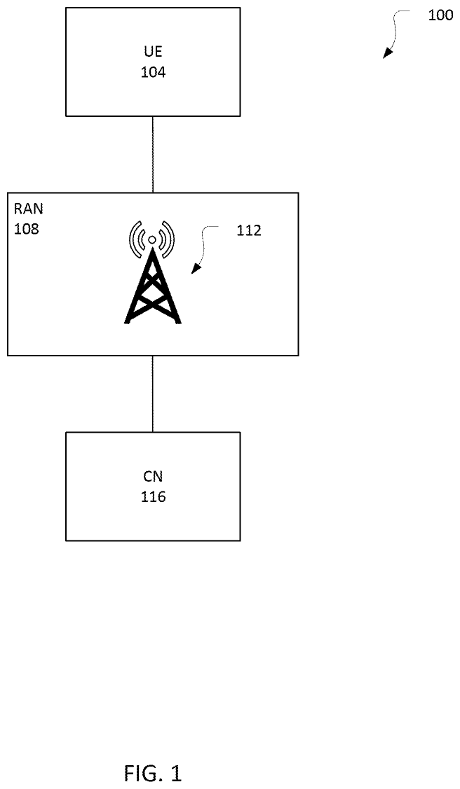

FIG. 1 illustrates a network environment 100 in accordance with some embodiments. The network environment 100 may include a UE 104 coupled with a radio access network (RAN) 108 that includes base station (BS) 112. The UE 104 and the BS 112 may communicate over air interfaces compatible with 3GPP TSs such as those that define Fifth Generation System (5GS) (or later) standards. The BS 112 may be a next generation node B (gNB) to provide one or more NR cells that present NR user plane and control plane protocol terminations toward the UE 104.

The RAN 108 may be coupled with a core network (CN) 116. The CN 116 may have a variety of network functions that provide services such as storing subscription information, authenticating UEs/network components, registering and tracking UEs, managing quality of service (QoS) aspects, controlling data sessions, and forwarding uplink/downlink traffic.

The UE 104 may be a redcap UE that has reduced device complexity and energy consumption as compared to a non-redcap UE. For example, the redcap UE 104 may have less transmit/receive capabilities as compared to a non-redcap UE. Some UE reduction features include reduced number of receive/transmit antennas (for example, less than four), UE bandwidth reduction (for example, up to 20 MHz), half-duplex frequency division duplexing, relaxed UE processing time, and relaxed UE processing capability.

Expected capabilities of redcap UE 104 may depend on the frequency range in which it operates. For example, if the redcap UE 104 operates in frequency range 1 (FR1), from 410 MHz to 7125 MHz, it may be expected to only support one receive (Rx) antenna and a maximum bandwidth of 20 MHz during and after initial access. If the redcap UE 104 operates in frequency range 2 (FR2), from 24.25 GHz to 52.6 GHz, it may be expected to support no more than two Rx antennas and a maximum bandwidth of 100 MHz during and after initial access. The support of multiple-input, multiple-output (MIMO) may also be optional for the redcap UE 104, while legacy UEs may be expected to support at least two Rx antennas.

A base station that supports redcap UEs may not be limited to operation in the bandwidth of the redcap UEs. For example, if the base station 112 supports redcap UEs, it may still operate with higher or lower bandwidths.

The base station 112 may broadcast support of redcap UEs in a system information block 1 (SIB1). This may prevent redcap UEs from camping on cells that do not support them. In some instances, a redcap UE may only be allowed to camp or register on a cell that supports redcap UEs.

In some frequency bands, 3GPP defines a maximum supported bandwidth of only 20 MHz in FR1 or 100 MHz in FR2. Further, support of four Rx antennas may not be mandatory for legacy UEs in these bands. In some instances, a redcap UE may operate on these bands if it can satisfy other capabilities that are expected from legacy UEs such as, for example, support of 18-bit radio link control (RLC)/packet data convergence protocol (PDCP) operation. If the redcap UE can support all the capabilities that are expected to be mandatorily supported by legacy UEs, then the redcap UE may attempt to register without even informing the network that it is a redcap UE. The network, without having knowledge that the UE is a redcap UE, may provide a configuration that is supported by the UE for operation within a given cell. This may result in a redcap UE operating in the cell as a non-redcap UE (which may also be referred to as a legacy UE).

Bandwidth/MIMO configurations may be specific to a cell. So, while some cells may have bandwidth/MIMO parameters that a redcap UE may support (for example, a maximum bandwidth of 20 MHz in FR1 or 100 MHz in FR2 and relaxed receive antenna requirements), other cells may not. Thus, there may be issues if a redcap UE operating as a normal UE in a cell with bandwidth/MIMO requirements that the redcap UE can support gets transferred to another cell in another frequency band having bandwidth/MIMO requirements that the redcap UE cannot support. Legacy base stations are not restricted from handing over a UE from a first cell with first bandwidth/MIMO requirements to a second cell with second bandwidth/MIMO requirements.

In some instances, redcap capability may be defined per band or per FR. This may imply that a redcap UE may be able to operate as a non-redcap UE in certain bands/FRs and as a redcap UE in other bands/FRs. A redcap UE may advertise, in its capability report, whether it supports redcap operation for individual bands/FRs.

In some instances, a legacy network may handover a redcap UE, which is operating as a legacy UE in that cell, to a target cell in a different band. If the target cell does not support redcap operation and the UE only supports redcap operation in the band of the target cell, an error may occur.

Consider, for example, that a UE provides a first base station, which supports redcap operation, with an indication of the UE's redcap capabilities. The first base station may understand the redcap capabilities of the UE and may perform a handover to a second base station that provides a legacy cell in a band in which the redcap UE supports legacy operation. The second base station may not understand the redcap capability extensions that indicate whether the UE supports redcap operation for individual bands. In this case, the second base station may transfer the UE to another legacy base station that operates on a band in legacy mode even though the UE only supports redcap operation in that band.

Embodiments describe signaling aspects that allow redcap UEs to operate in legacy and redcap-supporting networks without being configured with a configuration that is not supported by redcap. These embodiments may allow the legacy base stations to handle redcap UEs (by treating them as legacy UEs) in cases in which the redcap UE can operate as a legacy UE in these bands and handing over the UE to other legacy base stations where the redcap UE can operate as a legacy UE in those target bands. The signaling aspects of the present embodiments may also provide the ability to prevent legacy base stations from handing over redcap UEs, which are operating as non-redcap UE in the current cell, to another legacy base station that does not support redcap operation where the UE is expected to operate in redcap mode. The signaling aspects of the present embodiments may further enable redcap-supporting networks to handover redcap UEs to legacy networks where the redcap UEs can operate as legacy UEs in those target bands. The redcap-supporting networks may not allow redcap UEs to be handed over to legacy networks that do not support redcap operation in which the UE is expected to only operate in redcap mode. As described herein, the signaling aspects may be enabled by the UE reporting its capability information to the network at the time of registration. This capability report may only need to be transmitted once in accordance with some embodiments.

3GPP networks, both Long Term Evolution (LTE) and NR networks, use unaligned packet encoding rules (PER). Both the sender and the receiver know the type of message. The sender encodes the message using unaligned PER for a radio resource control (RRC) message and the receiver parses the bit string based on a known message structure.

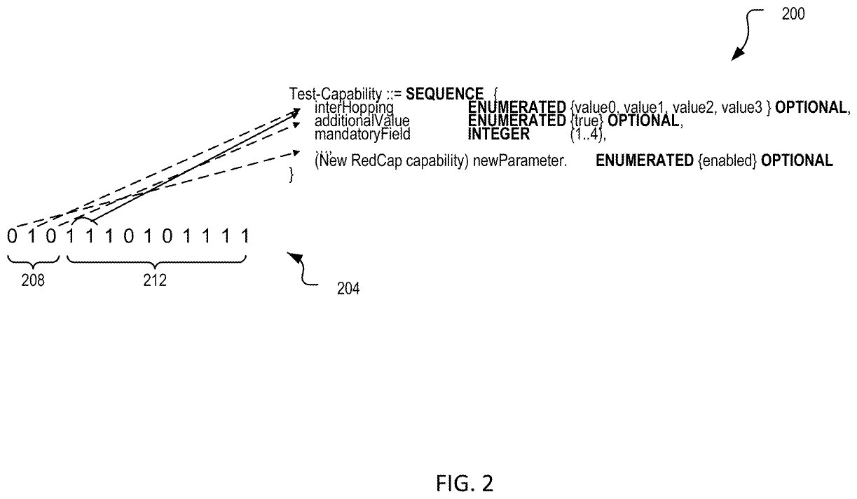

FIG. 2 illustrates a test-capability structure 200 and a corresponding bitstream 204 to illustrate PER aspects in accordance with some embodiments.

The test-capability structure 200 may be an RRC message structure known as a sequence in abstract syntax notation one (ASN.1). In some instances, RRC message structures, such as the test-capability structure 200, may also be referred to as IEs.

The test-capability structure 200 may include five IEs: interHopping, additionalValue; mandatoryField; extension marker ( . . . ); and new redcap capability. The interHopping, additionalValue, and new redcap capability IEs may be optional IEs.

The corresponding bitstream 204 includes a header 208 and a body 212. The header 208 may inform the receiver of presence or absence of optional elements (for example, which optional elements have corresponding information conveyed by the body 212). If there is an extension marker, then the presence or absence of fields after the extension marker are included in the header 208. The length of the header 208 may be determined by the presence/absence of content after the extension marker. The first bit of the header may indicate whether there is content after the extension marker. As shown, the header 208 includes a ‘0’ in the first bit, which means there is no content after the extension marker and, therefore, the header size is three bits. The second bit of the header 208 is shown as ‘1,’ which means the interHopping IE is present, and the third bit of the header 208 is shown as ‘0,’ which means the additionalValue IE is not present.

Following the header 208, the bits of the body 212 provide a value of the IEs that are present. Given that the interHopping IE includes four possible values, the first two bits of the body 212 are used to indicate the value of the interHopping IE (for example, value3 as shown).

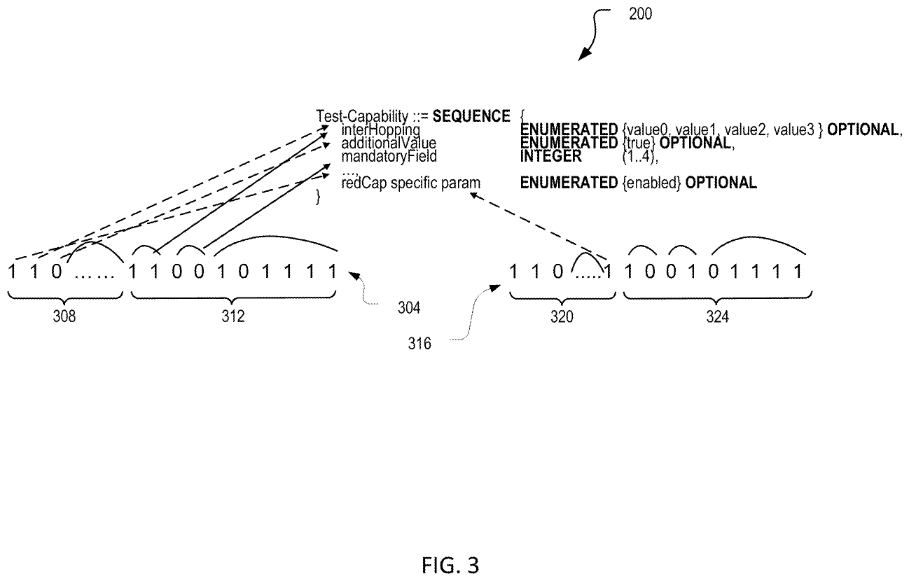

FIG. 3 illustrates the test-capability structure 200 and corresponding bitstreams 304 and 316 to illustrate PER aspects in accordance with some embodiments.

The bitstream 304 includes a header 308 and body 312; and bitstream 316 includes a header 320 and a body 324. Both header 308 and header 320 include a first bit set to ‘1’ to indicate that there is content after the extension marker.

Receivers that have not implemented the protocol beyond the extension marker (for example, receivers that do not support redcap operation) may ignore the content after the extension marker. With respect to bitstream 304, these receivers may interpret the length of the header 308 as three bits and may parse the header 308 to determine that interHopping is present and the additionalValue is not present. After the header 308, the next set of bits points to the value of IEs that are present. For example, the first two bits of the body 312 may indicate that the interHopping is value 3; the next two bits of the body 312 indicate that the mandatoryField has a value 1; and the next set of bits are not considered by the receivers to be part of the test-capability structure 200.

Receivers that have implemented the protocol beyond the extension marker (for example, redcap-enabled receivers) may consider the optional elements beyond the extension marker for header parsing. With respect to bitstream 316, these receivers would interpret the length of the header 320 to be four bits, including the information on the presence/absence of the redcap-specific parameter IE. In this instance, the redcap enabled receiver may parse the header 320 to determine that the interHopping IE is present based on the second bit of the header 320, the additionalValue IE is not present based on the third bit of the header 320, and the redcap-specific parameter IE is present based on the last bit of the header 320. After the header 320, the bits of the body 324 may convey the value of IEs that are present. In particular, the first two bits of the body 324 may indicate that the interHopping value includes a value of 2, the next two bits may indicate that the mandatoryField has a value of two, and the last five bits may include a bit that informs the redcap-enabled receiver of whether the redcap-specific parameter is enabled.

Thus, redcap UE capabilities added to an end of a bitstream may be ignored by legacy base stations.

If the UE has a redcap-specific capability, it should not be ignored by legacy base stations. Otherwise, the legacy base stations may not differentiate its actions for redcap UEs that are acting as legacy UEs. On the other hand, legacy base stations may not be required to understand that a UE is a redcap UE. If the redcap UE operates as a legacy UE in a band on which the legacy base station operates, there may be no need to change operation of the legacy network. However, if the redcap UE does not operate as a legacy UE in the band on which the legacy base station operates, the legacy base station should not allow the UE to camp on or handover to the cell. The camping part may be handled by the legacy base stations not broadcasting redcap support in the SIB1 and the redcap UEs not camping on these cells unless they operate as legacy UEs. However, for handovers, the source base station should not allow the handover, and there is again no requirement that the source base station should understand the redcap capability. The source base station could be a legacy base station as well, and act accordingly.

In some embodiments, information about a UE's redcap capability may be provided in a legacy section of the capability report. This may be on a per-band basis in accordance with some embodiments. The legacy base stations may use this information to understand at least something of the redcap UE capability. For example, the legacy section may include a does-not-support (DNS) indication that may be used to trigger the legacy base station to assume the UE cannot support some operations. In a handover scenario, the source base station may provide capability to the target base station. The target base station may then parse the capability before providing a configuration to the source base station to initiate the handover. If a redcap UE cannot operate as a legacy UE in a band of the target base station, the target base station may determine this from the DNS indication and determine that the UE cannot be handed over. As a result, the target base station may not provide the configuration to the source base station as part of the handover.

Various IEs of a UE capability message may be used to provide the DNS indication for the benefit of both the source and target base stations in handover configurations. In bands in which the UE cannot operate as a legacy UE, the DNS indication may be provided by including a non-valid value for an IE in a legacy section of the capability report. When a legacy network that does not support redcap operation parses the information element, it may assume the UE cannot operate in its cell based on the DNS indication. The IE used for the DNS indication in the legacy section may also be added to a redcap-specific extension of the capability report that may not be visible to a legacy base station. The IE in the redcap-specific extension may include a valid value of the IE to provide embedded content (for example, embedded capability information). Thus, when a base station that does support redcap operation receives the capability report, it may ignore the IE in the legacy section with the invalid value and may use the valid value of the IE based on the IE present in the redcap-specific extension. In bands in which the UE can operate as a legacy UE, the UE may not provide the DNS indication in the legacy section of the capability report. This may allow a legacy base station, which does not support redcap operation, to assume that the current UE can operate in its cell as a legacy UE.

In this manner, we may provide information of support or nonsupport per band in a manner that provides sufficient relevant information to both legacy and redcap-enabled base stations. This may enable the UE to operate as a redcap UE or non-redcap UE in each band based on the UE support.

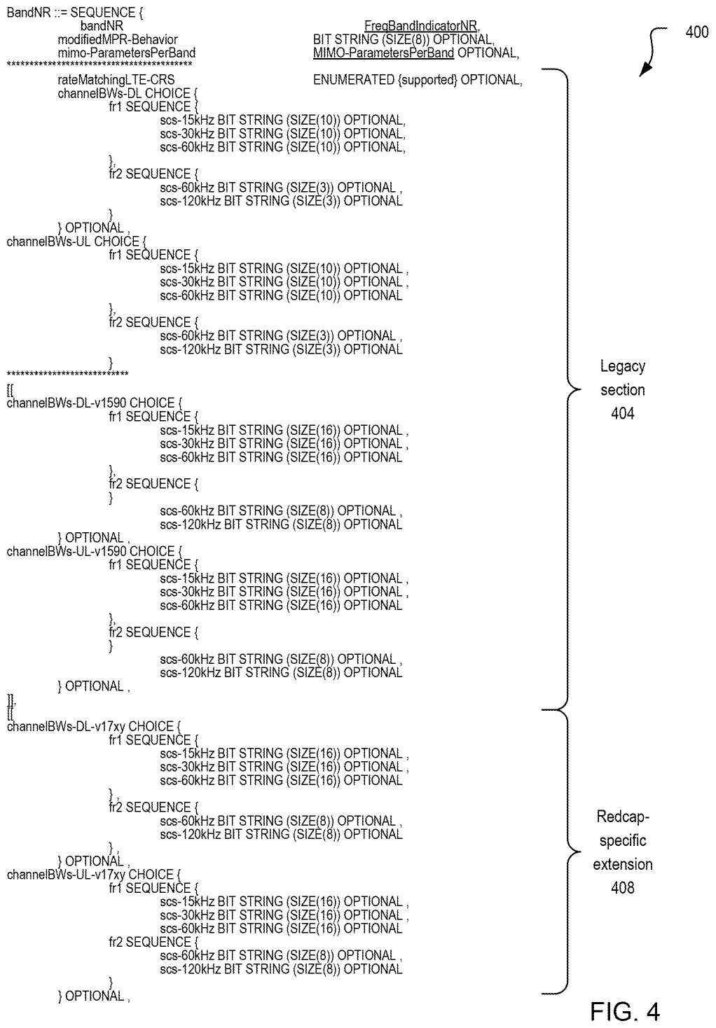

FIG. 4 illustrates a band NR sequence 400 that may be used to provide support indication accordance with some embodiments. The band NR sequence 400, which may also be referred to as a band NR IE, may include a legacy section 404 and a redcap-specific extension 408. A legacy base station may be able to parse the legacy section 404 and a redcap-enabled base station may be able to parse both the legacy section 404 and the redcap-specific extension 408.

In some embodiments, the UE 104 may provide a DNS indication by setting all bits of a channel bandwidth IE to zero in the legacy section 404. The UE 104 may also provide a copy of the channel bandwidth IE in the redcap-specific extension 408 with actual values of UL/DL channel bandwidths that are supported for a given FR.

A legacy base station may interpret the bits corresponding to the legacy section 404 to indicate that the UE does not support any bandwidth for any of the subcarrier spacings for this band. Thus, the legacy base station would not provide any configuration to the UE 104 as it does not know what bandwidths the UE 104 supports. Further, the legacy base station, acting as a source base station, may avoid configuring any measurements on this band.

A redcap-enabled base station may ignore the channel bandwidth IE that has the DNS indication in the legacy section 404. Instead, the RedCap-enabled base station may determine which UL/DL channel bandwidths are supported based on the actual values provided in the channel bandwidth IE in the redcap-specific extension 408.

In other embodiments, per-band IEs other than the channel bandwidth IE may be used to provide the DNS indication in the legacy section 404 and may be copied into the redcap-specific extension 408 with the actual value. For example, in some embodiments a modified MPR behavior (modified MPR-behavior) IE may be used. The UE 104 may report all zeros in the bitstream corresponding to the modifiedMPR-behavior IE in the legacy section 404, and may provide a copy of the modifiedMPR-behavior IE with an actual value. In typical operation, the modifiedMPR-behavior IE may need to include at least one MPR value that is supported. Thus, a legacy base station may interpret the modifiedMPR-behavior IE of the legacy section 404 with all zeros as an invalid value (and, therefore, the DNS indication) and may determine that it is unable to serve the UE. A redcap-enabled base station may look to the modifiedMPR-behavior IE embedded in the redcap-specific extension 408 to determine the actual value for the modifiedMPR-behavior.

In the event a per-band approach is not needed, the same logic may be applied elsewhere. For example, instead of the UE 104 reporting the DNS indication and embedded content in a per-band report, the UE 104 may report them in another place that is not specific to a particular band but will result in similar operation. That is, for example, the DNS indication is used by a legacy base station to determine the UE 104 cannot support a band provided by the legacy base station, while the embedded content is used by a RedCap-enabled base station to determine an actual capability.

Some embodiments may utilize per-UE signaling to communicate the DNS indication and embedded content. In one example, an access stratum (AS) release IE may be used to provide this information. An AS release IE may have the following structure:
AccessStratumRelease::=ENUMERATED {rel15, rel16, spare6, spare5, spare4, spare3, spare2, spare1, . . . }.

The spare values of the AS release IE are not to be set. If the UE 104 sets an access stratum release IE to a spare value in a legacy section, a legacy base station may be unable to comprehend the UE 104, for example, the legacy base station may interpret the IE to have an invalid value and, therefore, include the DNS indication. If a redcap-enabled base station determines one or more spare values are set in the AS release IE of the legacy section, it may ignore this IE and, instead, look to the values of the AS release IE in the redcap-specific extension for the embedded content.

Other IEs may be used for per-UE solutions as well. In some embodiments, it may be advantageous to select an IE that is mandatory for the UE 104 to report.

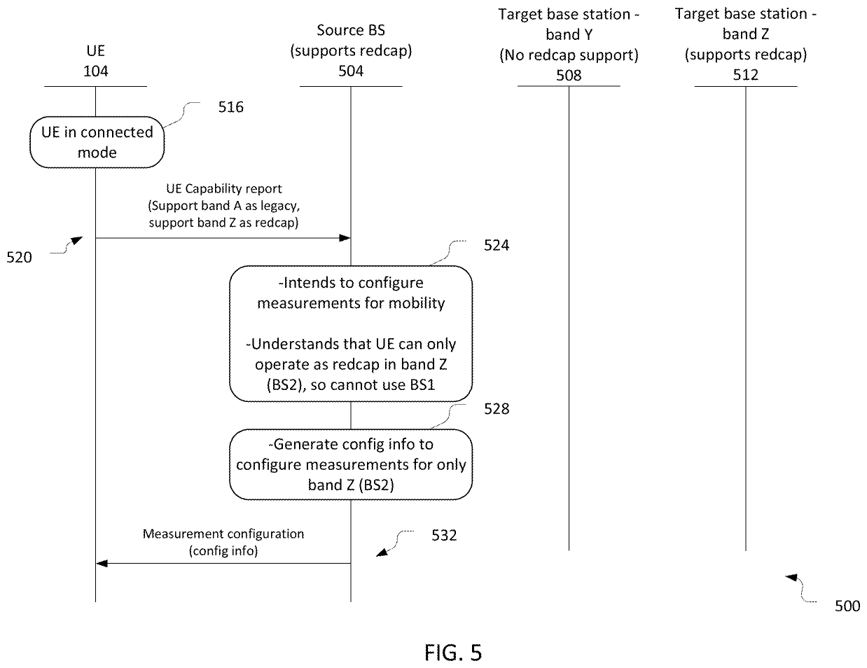

FIGS. 5-8 include signaling diagrams illustrating various concepts of the per-band/UE signaling of the DNS indication and embedded content in accordance with various embodiments.

FIG. 5 illustrates a signaling diagram 500 in accordance with some embodiments. The signaling diagram 500 illustrates operations among the UE 104, a source base station 504, a target base station 508, and a target base station 512. The source base station 504 and target base station 512 may both support redcap, while the target base station 508 may not. The target base station 508 may operate a cell in band Y, while the target base station 512 operates a cell in band Z.

At 516, the UE 104 may be in an RRC connected mode. The UE 104 may, at 520, transmit a UE-capability report to the source base station 504. The UE-capability report may indicate that the UE 104 supports band A as a legacy UE and band Z only as a redcap UE. The band Z capability information in the capability report may include a DNS indication in a legacy section and embedded content in a redcap-specific extension.

At 524, the source base station 504 may intend to configure the UE 104 with measurements for mobility purposes. The base station 504 may parse the UE-capability report to determine the appropriate measurements with which the UE 104 should be configured. The base station 504 may parse the band Z capability information and detect the DNS indication in the legacy section. As the base station 504 is redcap-enabled, it may also process the redcap-specific extension to obtain the actual value corresponding to the IE used for the DNS indication in the legacy section.

Based on the UE-capability report, the source base station 504 may understand that the UE 104 can only operate as a redcap UE in band Z and cannot operate in band Y. Therefore, the base station 504 may, at 528, generate configuration information to configure measurements for only band Z for potential handover to target base station 512.

At 532, the base station 504 may transmit the configuration information to the UE 104 in a measurement configuration message.

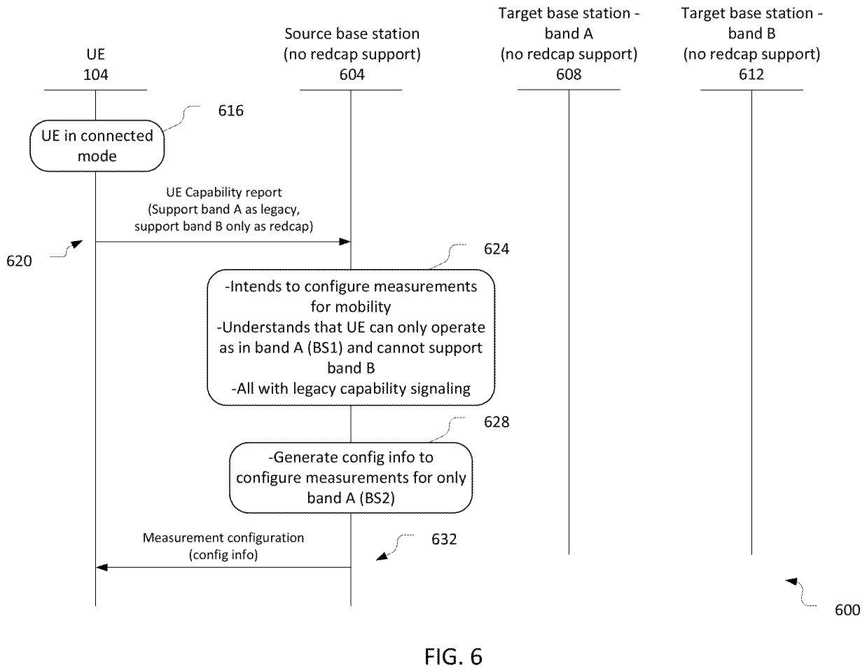

FIG. 6 illustrates a signaling diagram 600 in accordance with some embodiments. The signaling diagram 600 illustrates operations among the UE 104, a source base station 604, a target base station 608, and a target base station 612. The source base station 604, the target base station 608, and the target base station 612 are all legacy base stations that do not support redcap operation. The target base station 608 may operate a cell in band A, while the target base station 612 operates a cell in band B.

At 616, the UE 104 may be in an RRC connected mode. The UE 104 may, at 620, transmit a UE-capability report to the source base station 604. The UE-capability report may indicate that the UE 104 supports band A as a legacy UE and band B only as a redcap UE. The band A capability information in the capability report may include a legacy section with IEs having valid values, while the band B capability information in the capability report may include a DNS indication in a legacy section and an embedded capability in a redcap-specific extension.

At 624, the source base station 604 may intend to configure the UE 104 with measurements for mobility purposes. The source base station 604 may parse the UE-capability report to determine the appropriate measurements with which the UE 104 should be configured. The source base station 604 may parse the band A capability information to determine that the UE 104 supports band A as a legacy UE. The base station 604 may also attempt to parse the band B capability information. However, upon detecting the DNS indication in the legacy section, the source base station 604 may determine that the UE 104 simply does not support band B. Given that the source base station 604 is a legacy base station that cannot parse the redcap-specific extension, the source base station 604 may be unaware that the UE 104 actually supports band B for redcap only operation. Thus, based on the information the source base station 604 is able to discern from the UE-capability report, the source base station 604 may understand that the UE 104 can only operate in band A and cannot operate in band B. Therefore, the source base station 604 may, at 628, generate configuration information to configure measurements for only band A for potential handover to target base station 612.

At 632, the source base station 604 may transmit the configuration information to the UE 104 in a measurement configuration message.

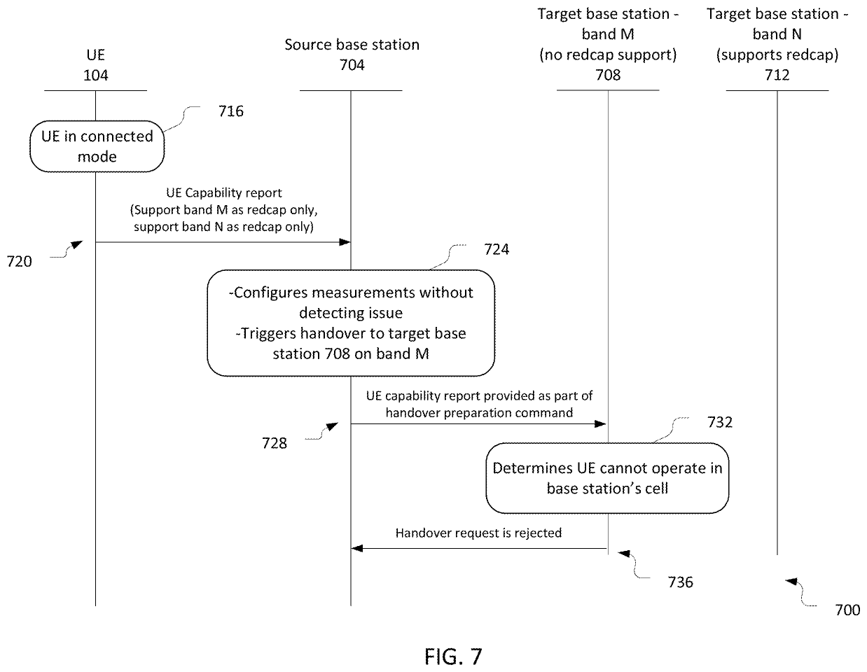

FIG. 7 illustrates a signaling diagram 700 in accordance with some embodiments. The signaling diagram 700 illustrates operations among the UE 104, a source base station 704, a target base station 708, and a target base station 712. The target base station 708 is a legacy base station that does not support redcap operation, while the target base station 712 does support redcap operation. The target base station 708 may operate a cell in band M, while the target base station 712 operates a cell in band N.

At 716, the UE 104 may be in an RRC connected mode. The UE 104 may, at 720, transmit a UE-capability report to the source base station 704. The UE-capability report may indicate that the UE 104 supports both band M and N only as a redcap UE. The band M/N capability information may include DNS indications in legacy sections and embedded content in redcap-specific extensions.

At 724, the source base station 704 may configure measurements in the M and N bands without detecting issues related to the limited support provided by target base station 708. After measurement configuration and report messages (not shown), the source base station 704 may trigger a handover to target base station 708 on band M.

At 728, the source base station 704 may forward the UE capability report to the target base station 708 as part of a handover preparation command.

At 732, the target base station 708 may attempt to parse the UE capability report. The target base station 708 may detect the DNS indication in the legacy section of the capability report and determine the UE 104 cannot operate in the cell provided by target base station 708. As a result, the target base station 708 may transmit a message at 736 indicating the handover request is rejected.

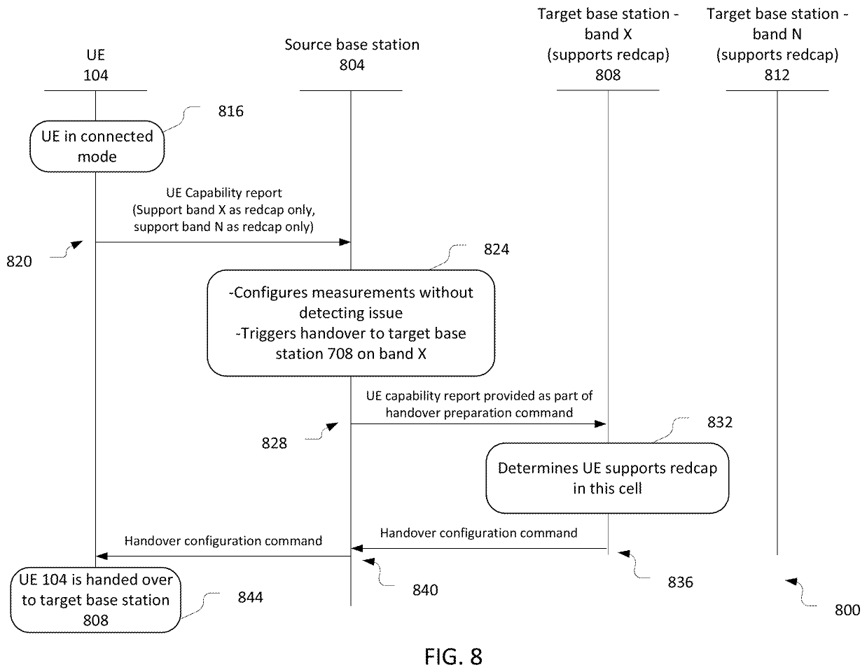

FIG. 8 illustrates a signaling diagram 800 in accordance with some embodiments. The signaling diagram 800 illustrates operations among the UE 104, a source base station 804, a target base station 808, and a target base station 812. Both the target base station 808 and the target base station 812 may support redcap operation. The target base station 708 may operate a cell in band X, while the target base station 812 operates a cell in band N.

At 816, the UE 104 may be in an RRC connected mode. The UE 104 may, at 820, transmit a UE-capability report to the source base station 804. The UE-capability report may indicate that the UE 104 supports both band X and N only as a redcap UE. The band X/N capability information may include DNS indications in legacy sections and embedded content in redcap-specific extensions.

At 824, the source base station 804 may configure measurements in the X and N bands without detecting issues related to the support provided by target base stations 808 and 812. After measurement configuration and report messages (not shown), the source base station 804 may trigger a handover to target base station 808 on band X.

At 828, the source base station 804 may forward the UE capability report to the target base station 808 as part of a handover preparation command.

At 832, the target base station 808 may attempt to parse the UE capability report. The target base station 808 may detect the DNS indication in the legacy section of the capability report and may further detect the embedded content in the redcap-specific extension. Based on the UE capability report, the target base station 808 may determine the UE 104 supports redcap operation in the cell provided by target base station 808. As a result, the target base station 808 may transmit a handover configuration command to the source base station 804 at 836. The source base station 804 may forward the handover configuration command to the UE 104 at 840 and, at 844, the UE 104 may be handed over to the target base station 808.

While the above embodiments describe per-band and per-UE approaches for transmitting the DNS indication and embedded content, other embodiments may use similar concepts for a per-FR approach. In these embodiments, instead of the UE 104 reporting this information per band, the UE may report the information in all bands of an FR. This may be done in a manner in which a legacy base station determines the UE 104 cannot support its band based on a DNS indication, while a redcap-enabled base station may ignore the DNS indication and look to the embedded content in the redcap-specific extension for the true definition of the capability.

The per-FR approach may be accomplished in a number of different ways by identifying legacy IEs that can be set with the DNS indication in a manner that a legacy base station determines the UE 104 does not support particular bands/FRs, while a copy of the legacy IE is added to the redcap-specific extension with the embedded content. This may be done in a manner that a legacy base station does not create a situation in which the UE 104 has to operate as a legacy UE in bands in which the UE 104 can only operate as a redcap UE.

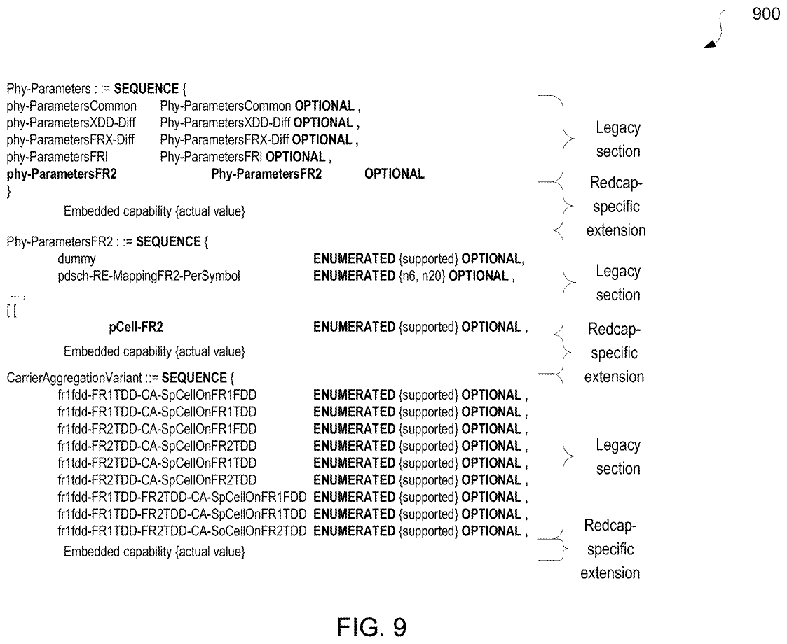

FIG. 9 illustrates IEs 900 that may be used to communicate a DNS indication and embedded content on a per-FR basis in accordance with some embodiments.

In a first embodiment, a physical layer parameter IE (e.g., phy-ParametersFR1 or phyParametersFR2) may include a legacy section with a value of the IE set with a DNS indication that causes a legacy base station to determine that the UE does not support operation on the corresponding FR for the band provided by the legacy base station. The physical layer parameter IE may also be copied into a redcap-specific extension to provide embedded content with an actual value of the IE.

In a second embodiment, a primary cell-FR2 (pCell-FR2) IE may include a legacy section with a value of the IE set with a DNS indication that causes a legacy base station to determine that the UE does not support operation on FR2 for the band provided by the legacy base station. The pCell-FR2 IE may also be copied into a redcap-specific extension to provide embedded content with an actual value of the IE.

In a third embodiment, an IE of a carrier aggregation (CA) variant sequence may include a legacy section with a value of the IE set with a DNS indication that causes a legacy base station to determine that the UE does not support operation on corresponding FR for the band provided by the legacy base station. The IE of the CA variant sequence may also be copied into a redcap-specific extension to provide embedded content with an actual value of the IE.

In some embodiments, a separate IE may be used to provide redcap specific capabilities. If the UE 104 does not support legacy operation, it may add its capabilities to the separate IE and remove capabilities from a legacy container. Consider, for example, that the UE 104 supports legacy operation in bands A, B, and C and redcap-only operation in bands X, Y, and Z. In some embodiments, the UE 104 may report a legacy IE (for example, supported band list for NR (supportedBandListNR)) that bands A, B, and C are supported. The supportedBandListNR may not indicate that bands X, Y, and Z are supported. Instead, the UE 104 may report a new IE (for example, a supported band list for NR redcap operation (supportedBandListNR-RedCap) IE), that bands X, Y, and Z are supported.

A legacy base station may parse the supportedBandListNR IE to determine support of bands A, B, and C as legacy operation and will ignore the supportedBandListNR-RedCap IE. Thus, the legacy base station will only hand over the UE 104 within bands A, B, and C. Given that the legacy base station will not be aware of bands supported for redcap-only operation, the legacy base station may not handover the UE 104 to redcap supporting base stations in the X, Y, or Z bands. A redcap-enabled base station, on the other hand, may parse both IEs to determine all the capabilities and may consider all bands (A, B, C, X, Y, and Z) for handover purposes.

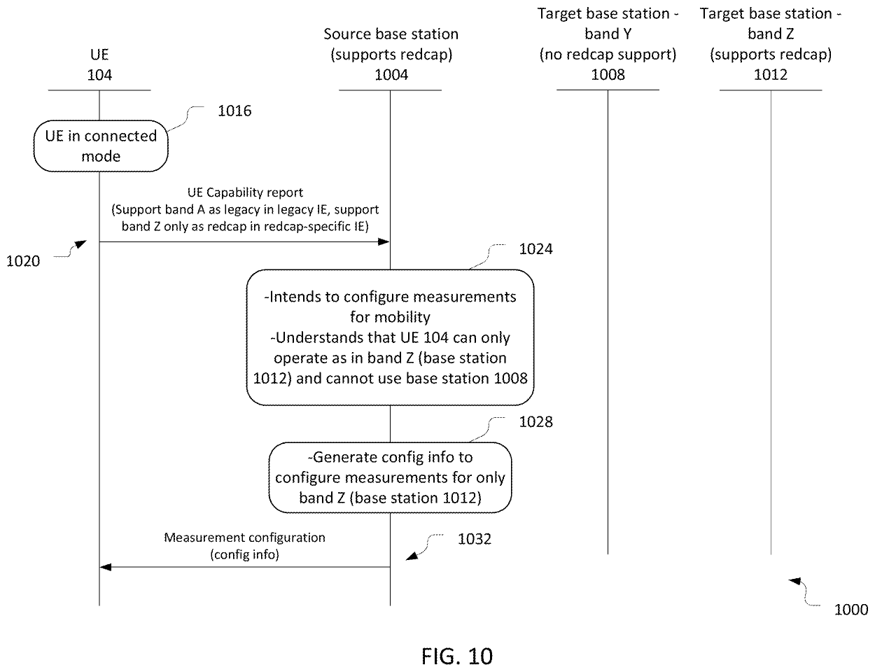

FIGS. 10-13 include signaling diagrams illustrating various concepts of using a separate IE for redcap-specific capabilities in accordance with various embodiments.

FIG. 10 illustrates a signaling diagram 1000 in accordance with some embodiments. The signaling diagram 1000 illustrates operations among the UE 104, a source base station 1004, a target base station 1008, and a target base station 1012. The target base station 1008 may be a legacy base station that does not support redcap operation, while the source base station 1004 and the target base station 1012 do support redcap operation. The target base station 1008 may operate a cell in band Y, while the target base station 512 operates a cell in band Z.

At 1016, the UE 104 may be in an RRC connected mode. The UE 104 may, at 1020, transmit a UE-capability report to the source base station 1004. The UE-capability report may include a legacy IE that indicates the UE 104 supports band A as a legacy UE. The UE-capability report may also include a redcap-specific IE that indicates the UE 104 supports Z as a redcap UE.

At 1024, the source base station 1004 may intend to configure the UE 104 with measurements for mobility purposes. The source base station 1004 may decode both the legacy IE and the redcap-specific IE of the UE-capability report to determine the capabilities of the UE 104. In this instance, the source base station 1004 may determine that the UE 104 can only operate in band Z with base station 1012 and cannot operate in band Y with base station 1008.

At 1028, the source base station 1004 may generate configuration information to configure measurements for only band Z with respect to base station 1012.

At 1032, the source base station 1004 may transmit the configuration information to the UE 104 in a measurement configuration message.

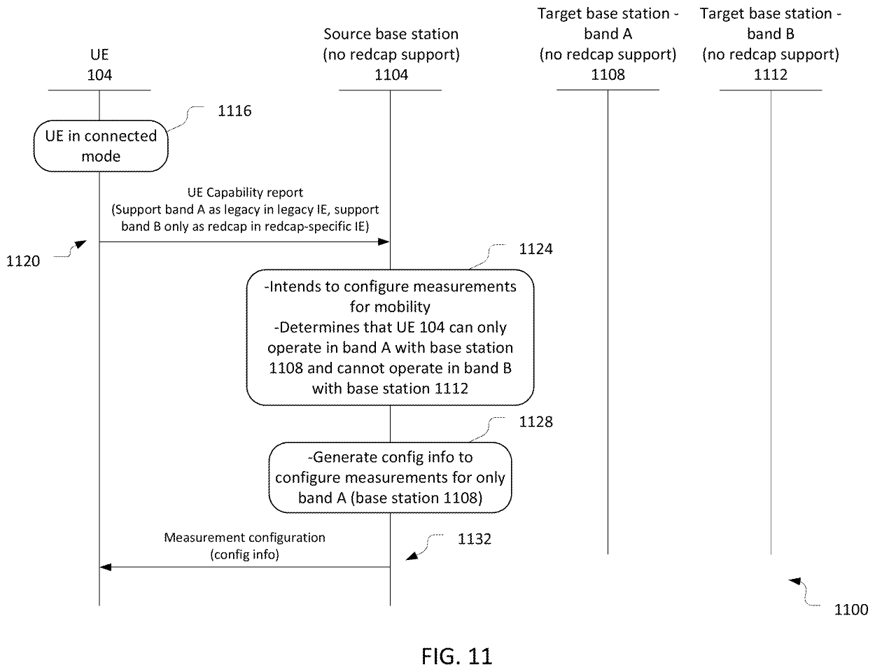

FIG. 11 illustrates a signaling diagram 1100 in accordance with some embodiments. The signaling diagram 1100 illustrates operations among the UE 104, a source base station 1104, a target base station 1108, and a target base station 1112. All of the source base station 1104, the target base station 1108, and the target base station 1112 may be legacy base stations that do not support redcap operation. The target base station 1108 may operate a cell in band A, while the target base station 1112 operates a cell in band B.

At 1116, the UE 104 may be in an RRC connected mode. The UE 104 may, at 1120, transmit a UE-capability report to the source base station 1104. The UE-capability report may include a legacy IE that indicates the UE 104 supports band A as a legacy UE. The UE-capability report may also include a redcap-specific IE that indicates the UE 104 supports band B as a redcap UE.

At 1124, the source base station 1104 may intend to configure the UE 104 with measurements for mobility purposes. Given that the source base station 1104 is a legacy base station, it may only decode the legacy IE. Thus, the base station 1104 may determine that the UE 104 can only operate in band A with base station 11108 and cannot operate in band B with base station 1112. The base station 1104 may have no knowledge that the UE 104 supports band B for redcap operation.

At 1128, the source base station 1104 may generate configuration information to configure measurements for only band A with respect to base station 1108.

At 1132, the source base station 1104 may transmit the configuration information to the UE 104 in a measurement configuration message.

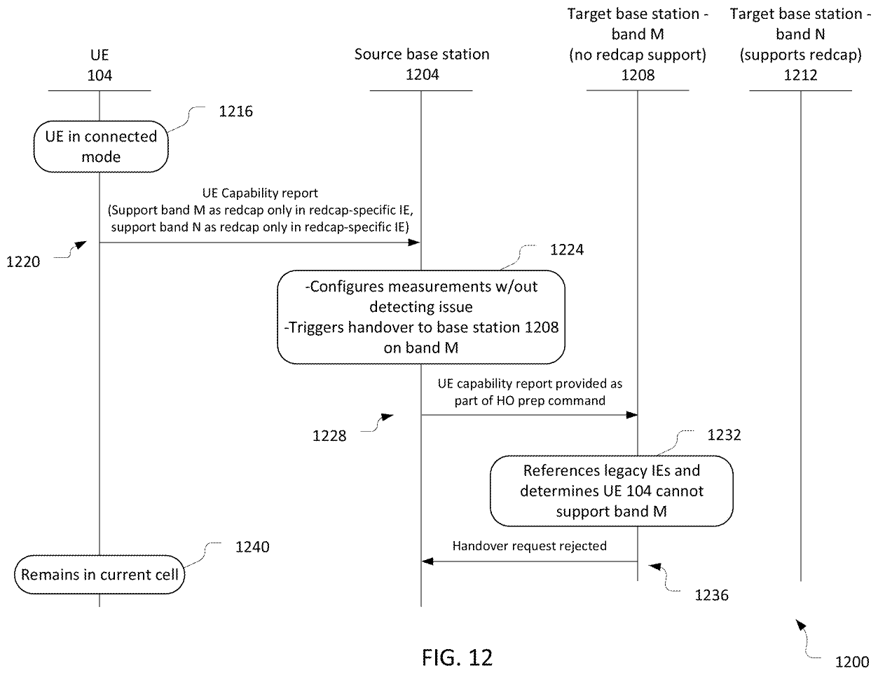

FIG. 12 illustrates a signaling diagram 1200 in accordance with some embodiments. The signaling diagram 1200 illustrates operations among the UE 104, a source base station 1204, a target base station 1208, and a target base station 1212. The target base station 1208 may be a legacy base station that does not support redcap operation, while the target base station 1212 does support redcap operation. The target base station 1208 may operate a cell in band M, while the target base station 1212 operates a cell in band N.

At 1216, the UE 104 may be in an RRC connected mode. The UE 104 may, at 1220, transmit a UE-capability report to the source base station 1204. The UE-capability report may include redcap-specific IEs that indicate the UE 104 supports bands M and N only as a redcap UE.

At 1224, the source base station 1204 may configure the UE 104 without detecting any support issues. After measurement configuration and report messages (not shown), the source base station 1204 may trigger a handover to target base station 1208 on band M.

At 1228, the source base station 1204 may forward the UE capability report to the target base station 1208 as part of a handover preparation command.

At 1232, the target base station 1208 may attempt to decode any legacy IEs in the UE capability report, the target base station 1208 may ignore the redcap-specific IEs. The target base station 1208 may determine the UE 104 cannot operate in its cell. As a result, the target base station 1208 may transmit a message at 1236 indicating the handover request is rejected.

At 1240, the UE 104 may remain in the current cell as it cannot be handed over to cells on which it cannot operate.

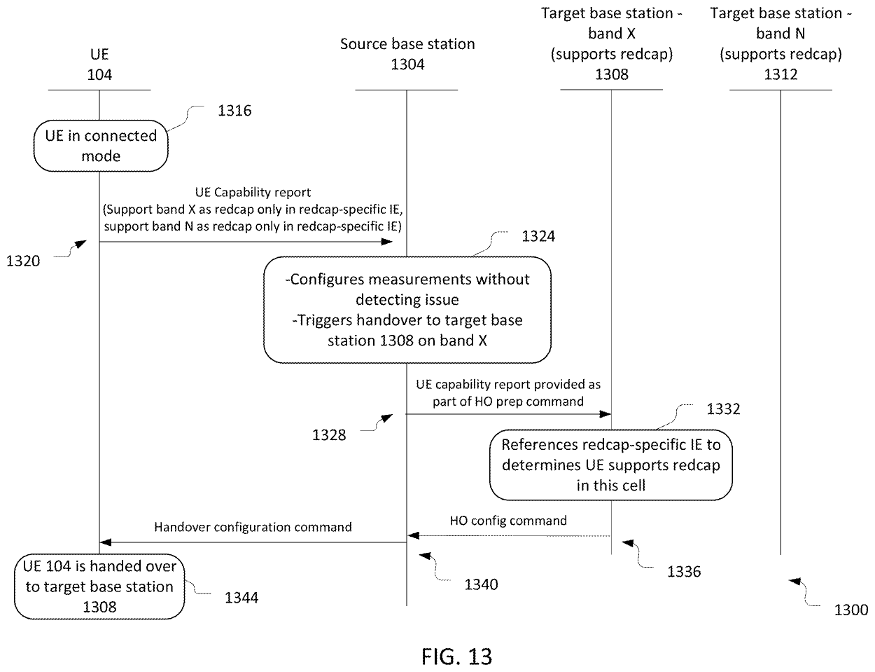

FIG. 13 illustrates a signaling diagram 1300 in accordance with some embodiments. The signaling diagram 1300 illustrates operations among the UE 104, a source base station 1304, a target base station 1308, and a target base station 1312. Both the target base station 1308 and the target base station 1312 may support redcap operation. The target base station 1308 may operate a cell in band X, while the target base station 1312 operates a cell in band N.

At 1316, the UE 104 may be in an RRC connected mode. The UE 104 may, at 1320, transmit a UE-capability report to the source base station 1304. The UE-capability report may include redcap-specific IEs that indicate that the UE 104 supports both band X and N only as a redcap UE.

At 1324, the source base station 1304 may configure measurements in the X and N bands without detecting issues related to the support provided by target base stations 1308 and 1312. After measurement configuration and report messages (not shown), the source base station 1304 may trigger a handover to target base station 1308 on band X.

At 1328, the source base station 1304 may forward the UE capability report to the target base station 1308 as part of a handover preparation command.

At 1332, the target base station 1308 may decode the redcap-specific IEs to determine that the UE 104 supports redcap operation in band X. As a result, the target base station 1308 may transmit a handover configuration command to the source base station 1304 at 1336. The source base station 1304 may forward the handover configuration command to the UE 104 at 1340 and, at 1344, the UE 104 may be handed over to the target base station 1308.

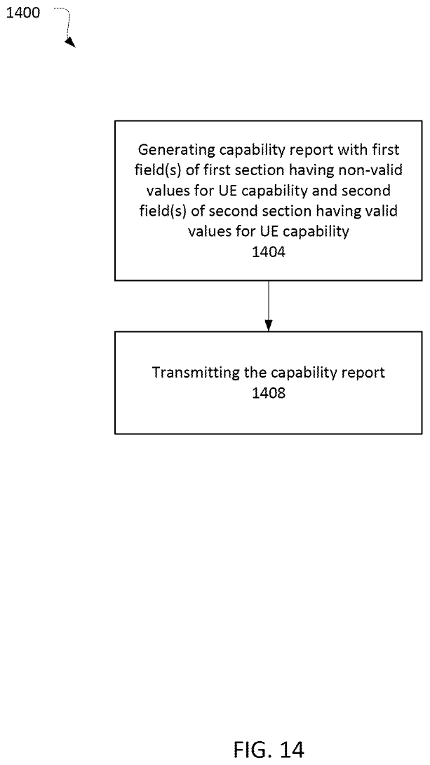

FIG. 14 illustrates an operation flow/algorithmic structure 1400 in accordance with some embodiments. The operation flow/algorithmic structure 1400 may be performed by a UE such as, for example, UE 104 or 1700, or components thereof, for example, processors 1704.

The operation flow/algorithmic structure 1400 may include, at 1404, generating a capability report. The capability report may be generated with first fields of a first section having non-valid value for a UE capability and second fields of a second section having valid values for the UE capability. The non-valid value may provide a DNS indication, while the valid values may correspond to embedded content. The first section may be a legacy section and the second section may be a redcap-specific extension. Thus, a legacy base station may detect the non-valid value and determine the UE does not support operation in a particular band/FR; however, a redcap-supporting base station may be able to determine the UE capability based on the valid values in the redcap-specific extension.

In some embodiments, the capability report may include an IE that has the first and second sections. The IE may correspond to a specific frequency band or FR. For example, the IE may be a bandNR IE and the first/second fields may be supported UL/DL channel bandwidth fields.

In some embodiments, the first/second fields may correspond to a modified MPR behavior IE. The non-valid values may correspond to all the bits in the IE being set to zero. In still other embodiments, the first/second fields may correspond to access stratum release IE, with the non-valid value being at least one of the spare bits set to one.

In embodiments in which the IE corresponds to a particular FR, the IE may be a phy-ParametersFR1 IE, phy-ParametersFR2 IE, a pCell-FR2 IE, or an IE in a CarrierAggregationVariant IE

The operation flow/algorithmic structure 1400 may further include, at 1408, transmitting the capability report. The capability report may be transmitted to a serving base station.

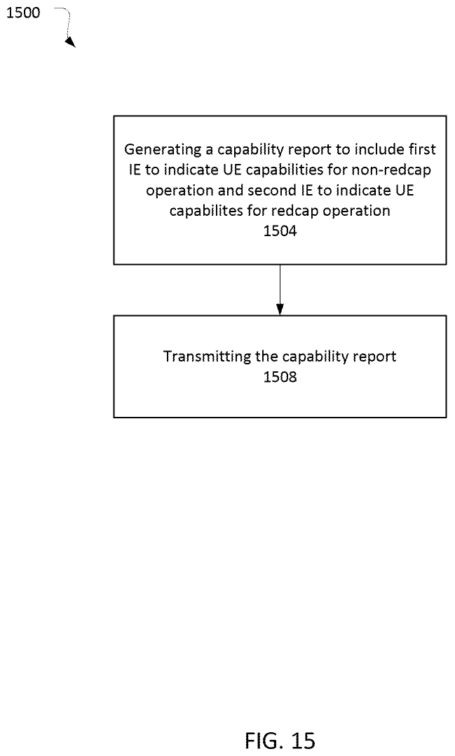

FIG. 15 illustrates an operation flow/algorithmic structure 1500 in accordance with some embodiments. The operation flow/algorithmic structure 1500 may be performed by a UE such as, for example, UE 104 or 1700, or components thereof, for example, processors 1704.

The operation flow/algorithmic structure 1500 may include, at 1504, generating a capability report to include a first IE to indicate UE capabilities for non-redcap operation and a second IE to indicate UE capabilities for redcap operation. The UE capabilities for non-recap operation and the UE capabilities for redcap operation may correspond to a common category of UE capabilities.

In some embodiments, the first IE may be a supportedBandListNR IE that includes a list of the bands that the UE supports for non-redcap (e.g., legacy) operation. The second IE may be a supportedBandListNR-Redcap IE that includes a list of bands that the UE supports for redcap operation only. In these embodiment, the common category of UE capabilities may be supported bands.

The operation flow/algorithmic structure 1500 may further include, at 1508, transmitting the capability report to a base station.

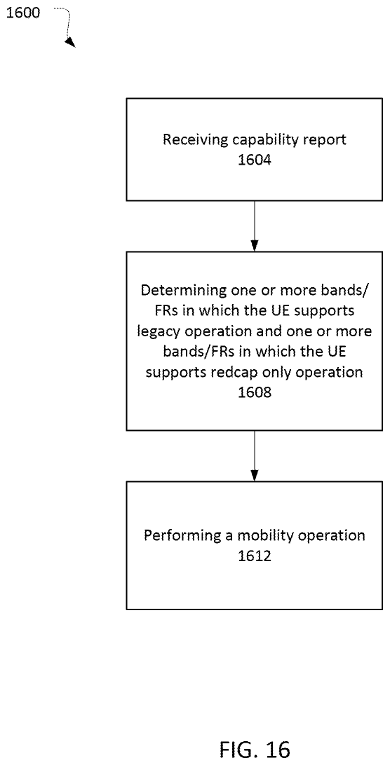

FIG. 16 illustrates an operation flow/algorithmic structure 1600 in accordance with some embodiments. The operation flow/algorithmic structure 1600 may be performed by a base station such as, for example, base station 112 or network node 1800, or components thereof, for example, processors 1804.

The operation flow/algorithmic structure 1600 may include, at 1604, receiving a capability report. If the base station is a serving base station, the capability report may be received from a UE as part of an initial registration process, or an update process. If the base station is a target base station, the capability report may be received from a serving base station as part of a handover process.

The operation flow/algorithmic structure 1600 may further include, at 1608, determining one or more bands/FRs in which the UE supports legacy operation or one or more bands/FRs in which the UE sports redcap only operation. In some embodiments, the base station may determine this information based on a DNS indication and embedded content within the capability report. In other embodiments, the base station may determine this information based on a legacy IE and a redcap specific IE included in the capability report.

The operation flow/algorithmic structure 1600 may further include, at 1612, performing a mobility operation. In some embodiments, the mobility operation may include configuring mobility measurements for the UE. The mobility measurements may be based on which bands/FRs are supported by the UE for redcap and legacy operation, as well as capabilities of base stations that provide neighbor cells for the UE. In other embodiments, the mobility operation may include a handover process. For example, the base station may determine if it supports the UE for handover. If the base station supports the UE, it may respond to a source base station with a handover configuration command. If the base station does not support the UE, it may respond to the source base station with a handover request rejection message.

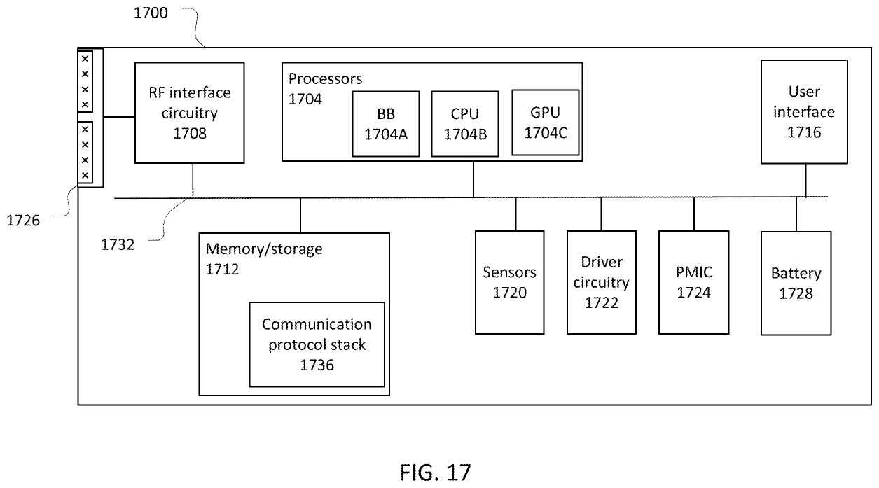

FIG. 17 illustrates a UE 1700 in accordance with some embodiments. The UE 1700 may be similar to and substantially interchangeable with UE 174 of FIG. 1.

The UE 1700 may be any mobile or non-mobile computing device, such as, for example, mobile phones, computers, tablets, XR devices, glasses, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1700 may include processors 1704, RF interface circuitry 1708, memory/storage 1712, user interface 1716, sensors 1720, driver circuitry 1722, power management integrated circuit (PMIC) 1724, antenna structure 1726, and battery 1728. The components of the UE 1700 may be implemented as integrated circuits (ICs), portions thereof, discrete electronic devices, or other modules, logic, hardware, software, firmware, or a combination thereof. The block diagram of FIG. 17 is intended to show a high-level view of some of the components of the UE 1700. However, some of the components shown may be omitted, additional components may be present, and different arrangement of the components shown may occur in other implementations.

The components of the UE 1700 may be coupled with various other components over one or more interconnects 1732, which may represent any type of interface, input/output, bus (local, system, or expansion), transmission line, trace, or optical connection that allows various circuit components (on common or different chips or chipsets) to interact with one another.

The processors 1704 may include processor circuitry such as, for example, baseband processor circuitry (BB) 1704A, central processor unit circuitry (CPU) 1704B, and graphics processor unit circuitry (GPU) 1704C. The processors 1704 may include any type of circuitry or processor circuitry that executes or otherwise operates computer-executable instructions, such as program code, software modules, or functional processes from memory/storage 1712 to cause the UE 1700 to perform operations as described herein.

In some embodiments, the baseband processor circuitry 1704A may access a communication protocol stack 1736 in the memory/storage 1712 to communicate over a 3GPP compatible network. In general, the baseband processor circuitry 1704A may access the communication protocol stack 1736 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1708.

The baseband processor circuitry 1704A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1712 may include one or more non-transitory, computer-readable media that includes instructions (for example, communication protocol stack 1736) that may be executed by one or more of the processors 1704 to cause the UE 1700 to perform various operations described herein. The memory/storage 1712 include any type of volatile or non-volatile memory that may be distributed throughout the UE 1700. In some embodiments, some of the memory/storage 1712 may be located on the processors 1704 themselves (for example, L1 and L2 cache), while other memory/storage 1712 is external to the processors 1704 but accessible thereto via a memory interface. The memory/storage 1712 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1708 may include transceiver circuitry and radio frequency front module (RFEM) that allows the UE 1700 to communicate with other devices over a radio access network. The RF interface circuitry 1708 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1726 and proceed to filter and amplify (with a low-noise amplifier) the signal. The signal may be provided to a receiver of the transceiver that down-converts the RF signal into a baseband signal that is provided to the baseband processor of the processors 1704.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1726.

In various embodiments, the RF interface circuitry 1708 may be configured to transmit/receive signals in a manner compatible with NR access technologies.

The antenna structure 1726 may include antenna elements to convert electrical signals into radio waves to travel through the air and to convert received radio waves into electrical signals. The antenna elements may be arranged into one or more antenna panels. The antenna structure 1726 may have antenna panels that are omnidirectional, directional, or a combination thereof to enable beamforming and multiple input, multiple output communications. The antenna structure 1726 may include microstrip antennas, printed antennas fabricated on the surface of one or more printed circuit boards, patch antennas, or phased array antennas. The antenna structure 1726 may have one or more panels designed for specific frequency bands including bands in FR1 or FR2.

The user interface 1716 includes various input/output (I/O) devices designed to enable user interaction with the UE 1700. The user interface 1716 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1700.

The sensors 1720 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1722 may include software and hardware elements that operate to control particular devices that are embedded in the UE 1700, attached to the UE 1700, or otherwise communicatively coupled with the UE 1700. The driver circuitry 1722 may include individual drivers allowing other components to interact with or control various I/O devices that may be present within, or connected to, the UE 1700. For example, the driver circuitry 1722 may include circuitry to facilitate coupling of a UICC (for example, UICC 148) to the UE 1700. For additional examples, driver circuitry 1722 may include a display driver to control and allow access to a display device, a touchscreen driver to control and allow access to a touchscreen interface, sensor drivers to obtain sensor readings of sensors 1720 and control and allow access to sensors 1720, drivers to obtain actuator positions of electro-mechanic components or control and allow access to the electro-mechanic components, a camera driver to control and allow access to an embedded image capture device, audio drivers to control and allow access to one or more audio devices.

The PMIC 1724 may manage power provided to various components of the UE 1700. In particular, with respect to the processors 1704, the PMIC 1724 may control power-source selection, voltage scaling, battery charging, or DC-to-DC conversion.

In some embodiments, the PMIC 1724 may control, or otherwise be part of, various power saving mechanisms of the UE 1700 including DRX as discussed herein.

A battery 1728 may power the UE 1700, although in some examples the UE 1700 may be mounted deployed in a fixed location, and may have a power supply coupled to an electrical grid. The battery 1728 may be a lithium ion battery, a metal-air battery, such as a zinc-air battery, an aluminum-air battery, a lithium-air battery, and the like. In some implementations, such as in vehicle-based applications, the battery 1728 may be a typical lead-acid automotive battery.

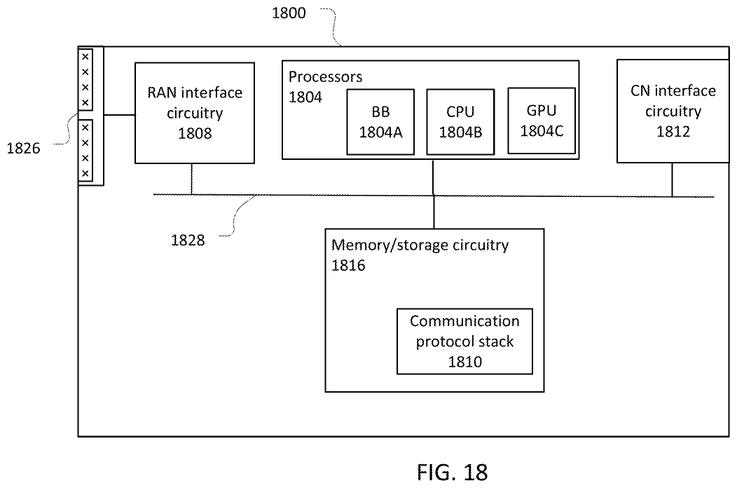

FIG. 18 illustrates a network node 1800 in accordance with some embodiments. The network node 1800 may be similar to and substantially interchangeable with base station 112 or source/target BS as described in any of FIGS. 5-8, 10-13.

The network node 1800 may include processors 1804, RF interface circuitry 1808 (if implemented as an access node), core network (CN) interface circuitry 1812, memory/storage circuitry 1816, and antenna structure 1826.

The components of the network node 1800 may be coupled with various other components over one or more interconnects 1828.

The processors 1804, RF interface circuitry 1808, memory/storage circuitry 1816 (including communication protocol stack 1810), antenna structure 1826, and interconnects 1828 may be similar to like-named elements shown and described with respect to FIG. 17.

The CN interface circuitry 1812 may provide connectivity to a core network, for example, a 5th Generation Core network (5GC) using a 5GC-compatible network interface protocol such as carrier Ethernet protocols, or some other suitable protocol. Network connectivity may be provided to/from the network node 1800 via a fiber optic or wireless backhaul. The CN interface circuitry 1812 may include one or more dedicated processors or FPGAs to communicate using one or more of the aforementioned protocols. In some implementations, the CN interface circuitry 1812 may include multiple controllers to provide connectivity to other networks using the same or different protocols.

In some embodiments, the network node 1800 may be coupled with transmit receive points (TRPs) using the antenna structure 1826, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method of operating a reduced capability (redcap) user equipment (UE), the method comprising: generating a capability report with one or more first fields in a first section and one or more second fields in a second section, wherein the one or more first fields and the one or more second fields correspond to a UE capability, the one or more first fields has a non-valid value for the UE capability, and the one or more second fields has a valid value for the UE capability; and transmitting the capability report to a base station.

Example 2 includes a method of example 1 or some other example herein, further comprising: wherein the second section is a redcap-specific extension.

Example 3 includes method of example 1 or some other example herein, wherein the first section and the second section are within an information element (IE) that corresponds to a frequency band.

Example 4 includes a method of example 3 or some other example herein, wherein the one or more first fields comprise one or more channel bandwidth fields for one or more subcarrier spacings, the non-valid value indicates no channel bandwidths are supported for the one or more subcarrier spacings, the one or more second fields comprise one or more channel bandwidth fields for the one or more subcarrier spacings, and the valid value indicates at least one channel bandwidth is supported for at least one subcarrier spacing of the one or more subcarrier spacings.

Example 5 includes a method of example 3 or some other example herein, wherein the one or more first fields comprise a modified maximum power reduction (MPR) behavior information element (IE) and the non-valid value is all bit values of the modified MPR behavior IE set to zero.

Example 6 includes a method of example 1 or some other example herein, wherein the one or more first fields comprise an access stratum release information element (IE) and the non-valid value comprises a spare bit of the access stratum release IE set to one.

Example 7 includes a method of example 1 or some other example herein, wherein the one or more first fields comprise a per-frequency-range (FR) information element (IE).

Example 8 includes a method of example 7 or some other example herein, wherein the per-FR IE is a physical-parameters FR 1 IE, a physical-parameters FR 2 IE, a primary cell FR 2 IE, or a carrier aggregation variant IE.

Example 9 includes a method of operating a reduced capability (redcap) user equipment (UE), the method comprising: generating a capability report to include a first information element (IE) to indicate UE capabilities for non-redcap operation and a second IE to indicate UE capabilities for redcap operation; and transmitting the capability report to a base station.

Example 10 includes a method of example 9 or some other example herein, wherein the first IE comprises a supported band list for new radio (supportedBandListNR) IE and the second IE comprises a supported band list for new radio for redcap operation (supportedBandListNR-Redcap) IE.

Example 11 includes a method of example 10 or some other example herein, wherein the supportedBandListNR IE indicates that the redcap UE supports legacy operation in one or more frequency bands and the supportedBandListNR-Redcap IE indicates that the redcap UE supports redcap operation in at least one frequency band.

Example 12 includes method of example 9 or some other example herein, wherein the UE capabilities for non-redcap operation and the UE capabilities for redcap operation correspond to a common category of UE capabilities.

Example 13 includes a method of operating a base station, the method comprising: receiving a capability report associated with a user equipment (UE), the capability report having an information element with a first section and a second section; detecting an indication that the UE does not support legacy operation based on one or more first fields in the first section, wherein the one or more fields are associated with a UE capability; and detecting a value of the UE capability based on one or more second fields in the second section.

Example 14 includes a method of example 13 or some other example herein, wherein the second section is a redcap-specific extension.

Example 15 includes a method of example 13 or some other example herein, wherein the first section and the second section are within a band capability information element (IE) that corresponds to a frequency band and the indication is that the UE does not support legacy operation in the frequency band.

Example 16 includes a method of example 15 or some other example herein, wherein the one or more first fields comprise one or more first channel bandwidth fields for one or more subcarrier spacings, the base station is to detect the indication based on the one or more first channel bandwidth fields indicating that no channel bandwidths are supported for the one or more subcarrier spacings, the one or more second fields comprise one or more second channel bandwidth fields for the one or more subcarrier spacings, and the value indicates at least one channel bandwidth is supported for at least one subcarrier spacing of the one or more subcarrier spacings.

Example 17 includes a method of example 15 or some other example herein, wherein the one or more first fields comprise a modified maximum power reduction (MPR) behavior information element (IE) and the base station is to detect the indication based on the modified MPR behavior IE having all bit values set to zero.

Example 18 includes a method of example 13 or some other example herein, wherein the one or more first fields comprise an access stratum release information element (IE) and the base station is to detect the indication based on a spare bit of the access stratum release IE being set to one.

Example 19 includes the method of example 13 or some other example herein, wherein the one or more first fields comprise an information element (IE) that is associated with a frequency range (FR) and the indication is that the UE does not support legacy operation in the FR.

Example 20 includes a method of example 19 or some other example herein, wherein the IE is a physical-parameters FR 1 IE, a physical-parameters FR 2 IE, a primary cell FR 2 IE, or a carrier aggregation variant IE.

Example 21 includes a method of example 13 or some other example herein, further comprising: configuring mobility measurements based on the indication that the UE does not support legacy operation.

Example 22 includes the method of example 13 or some other example herein, further comprising: determining whether the UE supports operation in a cell provided by the base station; and providing a handover message to a source base station based on said determining whether the UE supports operation in the cell. Example 23 may include an apparatus comprising means to perform one or more elements of a method described in or related to any of examples 1-22, or any other method or process described herein.

Example 24 may include one or more non-transitory computer-readable media comprising instructions to cause an electronic device, upon execution of the instructions by one or more processors of the electronic device, to perform one or more elements of a method described in or related to any of examples 1-22, or any other method or process described herein.

Example 25 may include an apparatus comprising logic, modules, or circuitry to perform one or more elements of a method described in or related to any of examples 1-22, or any other method or process described herein.

Example 26 may include a method, technique, or process as described in or related to any of examples 1-22, or portions or parts thereof.

Example 27 may include an apparatus comprising: one or more processors and one or more computer-readable media comprising instructions that, when executed by the one or more processors, cause the one or more processors to perform the method, techniques, or process as described in or related to any of examples 1-22, or portions thereof.

Example 28 may include a signal as described in or related to any of examples 1-22, or portions or parts thereof.

Example 29 may include a datagram, information element, packet, frame, segment, PDU, or message as described in or related to any of examples 1-22, or portions or parts thereof, or otherwise described in the present disclosure.

Example 30 may include a signal encoded with data as described in or related to any of examples 1-22, or portions or parts thereof, or otherwise described in the present disclosure.

Example 31 may include a signal encoded with a datagram, IE, packet, frame, segment, PDU, or message as described in or related to any of examples 1-22, or portions or parts thereof, or otherwise described in the present disclosure.

Example 32 may include an electromagnetic signal carrying computer-readable instructions, wherein execution of the computer-readable instructions by one or more processors is to cause the one or more processors to perform the method, techniques, or process as described in or related to any of examples 1-22, or portions thereof.

Example 33 may include a computer program comprising instructions, wherein execution of the program by a processing element is to cause the processing element to carry out the method, techniques, or process as described in or related to any of examples 1-22, or portions thereof.

Example 34 may include a signal in a wireless network as shown and described herein.

Example 35 may include a method of communicating in a wireless network as shown and described herein.

Example 36 may include a system for providing wireless communication as shown and described herein.

Example 37 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-20. (canceled)

21. One or more non-transitory, computer-readable media having instructions that, when executed, cause processing circuitry to:
generate a capability report with one or more first fields in a first section and one or more second fields in a second section, wherein the one or more first fields and the one or more second fields correspond to a UE capability, the one or more first fields has a non-valid value for the UE capability, and the one or more second fields has a valid value for the UE capability; and
output the capability report for transmission to a base station.

22. The one or more non-transitory, computer-readable media of claim 21, wherein the second section is a redcap-specific extension.

23. The one or more non-transitory, computer-readable media of claim 21, wherein the first section and the second section are within an information element (IE) that corresponds to a frequency band.

24. The one or more non-transitory, computer-readable media of claim 23, wherein the one or more first fields comprise one or more channel bandwidth fields for one or more subcarrier spacings, the non-valid value indicates no channel bandwidths are supported for the one or more subcarrier spacings, the one or more second fields comprise one or more channel bandwidth fields for the one or more subcarrier spacings, and the valid value indicates at least one channel bandwidth is supported for at least one subcarrier spacing of the one or more subcarrier spacings.

25. The one or more non-transitory, computer-readable media of claim 23, wherein the one or more first fields comprise a modified maximum power reduction (MPR) behavior information element (IE) and the non-valid value is all bit values of the modified MPR behavior IE set to zero.

26. The one or more non-transitory, computer-readable media of claim 21, wherein the one or more first fields comprise an access stratum release information element (IE) and the non-valid value comprises a spare bit of the access stratum release IE set to one.

27. The one or more non-transitory, computer-readable media of claim 21, wherein the one or more first fields comprise a per-frequency-range (FR) information element (IE).

28. The one or more non-transitory, computer-readable media of claim 27, wherein the per-FR IE is a physical-parameters FR 1 IE, a physical-parameters FR 2 IE, a primary cell FR 2 IE, or a carrier aggregation variant IE.

29. An apparatus comprising:
one or more processors to:
generate a capability report to include a first information element (IE) to indicate user equipment (UE) capabilities for non-reduced capability (redcap) operation and a second IE to indicate UE capabilities for redcap operation; and
output the capability report for transmission to a base station; and
interface circuitry coupled with the one or more processors to enable communication.

30. The apparatus of claim 29, wherein the first IE comprises a supported band list for new radio (supportedBandListNR) IE and the second IE comprises a supported band list for new radio for reduced capability operation (supportedBandListNR-Redcap) ILE.

31. The apparatus of claim 30, wherein the supportedBandListNR IE indicates that the redcap UE supports legacy operation in one or more frequency bands and the supportedBandListNR-Redcap IE indicates that the redcap UE supports redcap operation in at least one frequency band.

32. The apparatus of claim 29, wherein the UE capabilities for non-redcap operation and the UE capabilities for redcap operation correspond to a common category of UE capabilities.

33. A method comprising:
receiving a capability report associated with a user equipment (UE), the capability report having an information element with a first section and a second section;
detecting an indication that the UE does not support legacy operation based on one or more first fields in the first section, wherein the one or more fields are associated with a UE capability; and
detecting a value of the UE capability based on one or more second fields in the second section.

34. The method of claim 33, wherein the second section is a reduced capability (redcap)-specific extension.

35. The method of claim 33, wherein the first section and the second section are within a band capability information element (IE) that corresponds to a frequency band and the indication is that the UE does not support legacy operation in the frequency band.

36. The method of claim 35, wherein the one or more first fields comprise one or more first channel bandwidth fields for one or more subcarrier spacings, and said detecting the indication is based on the one or more first channel bandwidth fields indicating that no channel bandwidths are supported for the one or more subcarrier spacings, the one or more second fields comprise one or more second channel bandwidth fields for the one or more subcarrier spacings, and the value indicates at least one channel bandwidth is supported for at least one subcarrier spacing of the one or more subcarrier spacings.

37. The method of claim 35, wherein the one or more first fields comprise a modified maximum power reduction (MPR) behavior information element (IE) and said detecting the indication is based on the modified MPR behavior IE having all bit values set to zero.

38. The method of claim 33, wherein the one or more first fields comprise an access stratum release information element (IE) and said detecting the indication is based on a spare bit of the access stratum release IE being set to one.

39. The method of claim 33, wherein the one or more first fields comprise an information element (IE) that is associated with a frequency range (FR) and the indication is that the UE does not support legacy operation in the FR.

40. The method of claim 39, wherein the IE is a physical-parameters FR 1 IE, a physical-parameters FR 2 IE, a primary cell FR 2 IE, or a carrier aggregation variant IE.
